(19) United States
(12) Patent Application Publication
(10) Pub. No.: US 2007/0187447 A1
(43) Pub. Date: Aug. 16, 2007

(54) Hitch Assembly

(76) Inventor: Peter Hamann, Del Rio, TN (US)

Correspondence Address: KENYON D. POTTER, 1180 EDDY ST. UNIT C, SAN FRANCISCO, CA, 94109, US

(21) Appl. No.: 11/548,483

(22) Filed: Oct. 11, 2006

Related U.S. Application Data
(60) Provisional application No. 60/725,969, filed on Oct. 12, 2005.

(51) Int. Cl. A01K 97/10; B60R 9/00; B60R 11/00

(52) U.S. Cl. 224/519; 43/21.2; 224/520; 224/521; 224/922

(57) ABSTRACT

An improved hitch assembly is described for mounting accessories while simultaneously towing a trailer. Examples of accessories include a fishing rod holder, a bicycle rack, a bridge, platform, and so on. The invention also includes a retrofit device for mounting accessories on existing hitches and an adapter device for mounting accessories on vehicles with wide bumpers.

### PRIORITY CLAIM

The benefit under 35 U.S.C. Section 119(e) of U.S. Provisional Application No. 60/725,969, filed on Oct. 12, 2005, is hereby claimed. U.S. Provisional Application No. 60/725,969 is hereby incorporated by reference in its entirety.

### FIELD OF THE INVENTION

This invention relates to devices for holding fishing rods, or poles, and other outdoor gear, and in particular, to devices for transportation or hauling of such outdoor gear.

### BACKGROUND OF THE INVENTION

The sport of fishing often requires the transportation and hauling of fishing rods or poles to and from the fishing destination or the location of the boat dock. This is especially true of smaller boats which do not have room on board to stow rods and poles. However, trucks and other vehicles for transporting and hauling persons and other gear are not designed by original equipment manufacturers to transport or haul fishing rods or poles. As a result, many persons find it necessary to place rods or poles in the bed of a pickup truck or on the roof rack above the cabin. Yet, use of the bed or rack takes up valuable space that could be utilized for other materials or gear.

Other persons who are avid fishermen and outdoor enthusiasts would prefer to use products specifically designed to transport fishing rods or poles. It is envisioned that such devices would typically be made by after-market or third party companies for outdoor enthusiasts similar to hitch mounted racks for transporting of bicycles.

In the design of such devices, the length of fishing rods or poles is one of the key design attributes. The typical length of the fishing rods or poles hinders portability unless the design of a rod or pole comprises two or more pieces that are joined together in operation. However, a rod or pole with a joint is more costly to manufacturer and the joint must be designed to resist significant bending stress at the location of the joint. Thus, rods or poles with joints are generally limited to use for fishing for smaller fish such as fly fishing.

Another design attribute is the girth required of the device to accommodate the reel which often remains mounted on the rod or pole. Still another design attribute required of the device is a cushioning element to protect the rods or poles which have a material composition, e.g. fiberglass, that is prone to damage from rough handling. Still yet another design attribute required of the device is a locking element to protect the rods or poles, which often have substantial value, from theft while unattended during transit such as at a rest stop or filling station.

The prior art shows many examples of devices for holding of fishing rods or poles. In addition, the prior art shows several examples of devices for holding of fishing rods or poles during transportation or hauling. Typically, these devices teach the holding of fishing rods and reels securely on the rack or inside the cabin of the vehicle. Other devices teach the holding of fishing rods on the front bumper or along the sides of a vehicle. In addition, one device for holding of fishing rods or poles is designed to attachment to the hitch of a vehicle. U.S. Pat. No. 5,205,446 to Greenberg describes a holder of fishing rods that can be mounted to a hitch. However, patent '446 does not teach a device or method for simultaneously attaching a trailer and a rod nor does it teach a device or method to secure and lock the rods or poles in the rod holder.

U.S. Pat. No. 6,874,804 to Reese et al. describes a device for simultaneously attaching a trailer in tow and an accessory for use in work, e.g. a basket, or pleasure such as bicycles. Yet, Reese et al. does not teach a device or method for simultaneously attaching a trailer in tow and a rod holder to the hitch. Additionally, none of the prior art teaches how to securely lock the rods or poles to prevent their theft or unauthorized use.

None of the prior art describes how to retrofit an existing tongue to enable simultaneous attachment of an accessory. Further, none of the prior art describe how to reduce vibration in the connection between a receiver and an accessory secured by a pin.

### SUMMARY OF THE INVENTION

The present invention overcomes the disadvantages of the prior art because the present invention teaches a device capable of attaching to a hitch of a vehicle and which is easily installed and removed after use. The device easily, quickly, slides into the existing trailer hitch mechanism, rather than having to be bolted to the vehicle, its front or rear bumper, its side, interior walls or roof rack.

An object of the present invention is to enable the simultaneous use of the hitch to pull a trailer in tow and support a holder for fishing rods or other outdoor gear without having to remove the holder of the fishing rods or other outdoor gear.

Another object of the invention is to protect fishing rods or poles from damage by firmly clamping the rods or poles to an upper crossbar.

Another object of the invention is to protect fishing rods or poles from theft by allowing a user to lock the rods in place. The device secures rods or poles with drop pin or padlock alternatives.

Another object of the invention is to provide for vertical adjustment of the top cross bar to fit and hold taller rods or poles. In one embodiment, the column element is capable of telescoping, whereby the upper part of the column element, including the top crossbar, can extend upward to accommodate taller rods or poles and still secure them.

Another object of the invention is to transport a plurality of rods or poles in interspaced relation, thereby avoiding contact between adjacent rods or poles.

Another object of the invention is to utilize the existing hitch, thereby avoiding special mounting requirements, e.g. bolts or screws, to attach the device to the vehicle.

Another object of the invention is to enable the user to transport or haul a large number of rods or poles, e.g. 8 or more, to accommodate a group of persons that may not have their own rods or poles.

Another object of the invention is to enable the user to retrofit the existing user's hitch without having to replace the tongue that fits into the hitch's receiver.

Another object of the invention is to reduce the vibration in the connection between an accessory and a receiver.

### BRIEF DESCRIPTION OF THE DRAWINGS

For a fuller understanding of the nature and object of the invention, reference should be made to the following detailed description in conjunction with the accompanying drawings in which:

FIG. 1 is a perspective view of a device for holding a plurality of fishing rods or poles.

FIGS. 2A, 2B, 2C and 2D are side views of alternate embodiments of the device.

FIG. 3 is a front view of the device.

FIG. 3A is a partial side view of the device having a single lower crossbar.

FIG. 4 is a sectional view of the device.

FIGS. 5A and 5B are top views of alternate configurations of the retainer bar.

FIG. 6 is a partial top of one configuration of the retainer bar.

FIGS. 6A, 6B, and 6C are detailed views of the retainer bar, latch, and lock assembly.

FIGS. 7 and 8 are perspective views of the device coupled to the rear of a vehicle.

FIG. 9 is a front view of the device after fabrication and assembly.

FIGS. 10 through 13 are various views of the device during fabrication and/or assembly.

FIG. 14 is an exploded view of a retrofit device for mounting an accessory.

FIG. 15 is a perspective view of the retrofit device after fabrication and assembly.

FIG. 16 is a perspective view of the retrofit device positioned on a tongue.

FIG. 17 is an exploded view of the retrofit device and the tongue.

FIG. 18 is a side view of the retrofit device positioned on the tongue.

FIGS. 19A and 19B are perspective views of the retrofit device positioned on the tongue and alternative accessories.

FIG. 20 is a perspective view of the retrofit device positioned on the tongue and an adapter device.

FIG. 21 is a side view of the retrofit device positioned on the tongue and the adapter device.

Similar reference numerals and characters refer to similar parts throughout the drawings.

### DETAILED DESCRIPTION OF THE INVENTION

With reference to all the drawing figures: an upright column element is depicted by numeral 10; crossbars are depicted by numerals 20, 30 and 40; hinged retainer bars are depicted by numerals 50 and 60; and rod holders are each depicted by numeral 90.

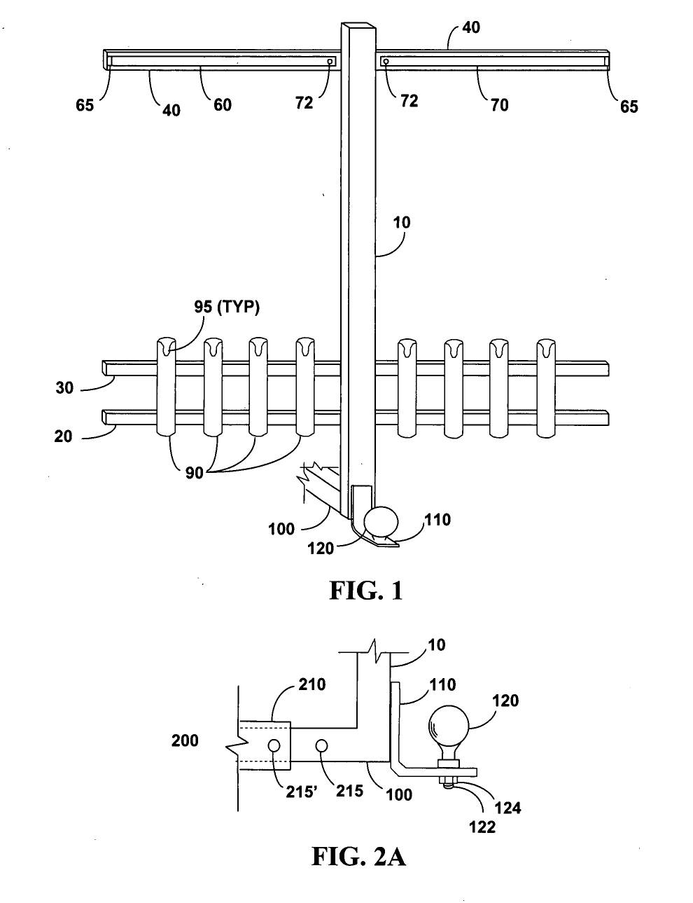

Referring to FIGS. 1 and 3, crossbars 20, 30, and 40 are connected at their midpoints to the upright column element 10. In the preferred embodiment, the upright column element is a square tube of 2 inch nominal diameter and 0.188 inch wall thickness, the crossbars are square tube of 1 inch nominal diameter and 0.188 inch wall thickness, and the upright column element and crossbars are composed of structural steel such as ASTM A500, Grade B or Grade C. Yet, the upright column may be a rectangular tube or round pipe having a different cross-sectional shape, e.g. round, oval, etc.; a different wall thickness, e.g. 0.250 inch, or even having a solid cross-section e.g. a flat bar; and composed of a different material, e.g. aluminum, wood, fiberglass, plastic, etc.

Similarly, referring to FIGS. 1, 3 and 3A, the crossbars may vary in cross-sectional shape, wall thickness, and material composition. In the preferred embodiment, the lower crossbars 20 and 30 are positioned about 8 inch apart to support the rod holders 90. Yet, crossbars 20 and 30 may be positioned from 2 to 16 inches apart or both crossbars may be replaced with a single crossbar 25 such as a plate or channel having a web of at least 3 inches depth and 0.188 inch thickness or a plate having dimensions of at least 3 inches in width and 0.188 inch thickness, and composed of structural steel such as ASTM A36 or A572. In one embodiment, the upper crossbar 40 is positioned about 4 feet above crossbar 30. Yet, crossbar 40 may be positioned from 1 to 7 feet above the centroid of crossbars 20 and 30 (or single crossbar 25) and typically between 3 and 5 feet above the centroid. In another embodiment, the crossbars 20 and 30 are connected together by a vertical strut 22 positioned at each end and the vertical strut is a flat bar. In one embodiment, the crossbars are connected to the upright column element by electric-arc welding. Yet, the crossbars may be connected to the upright column element by gas-flux welding, chemical welding, adhesives, or mechanical connectors, e.g. bolts or screws depending on the material composition of the upright column element and the crossbars. In the preferred embodiment, all exposed metal surfaces would have a polyester powder coated finish or a coating system of equivalent durability.

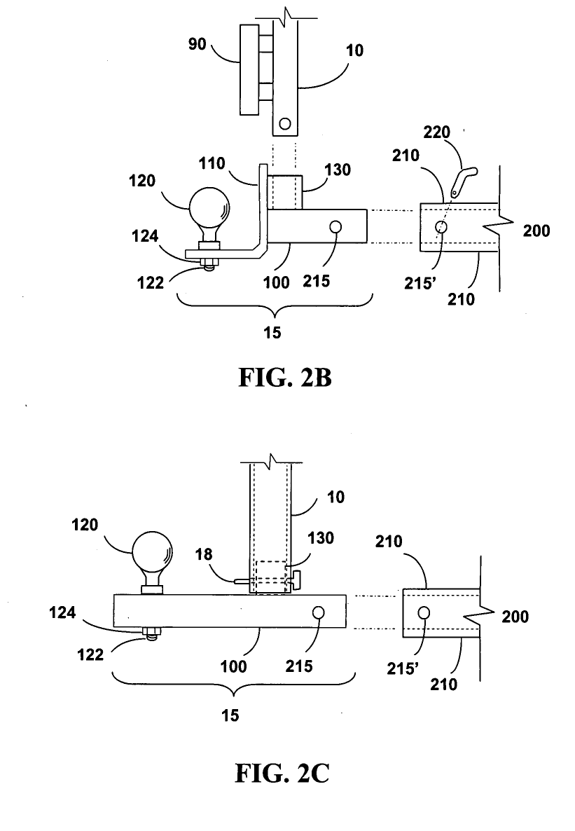

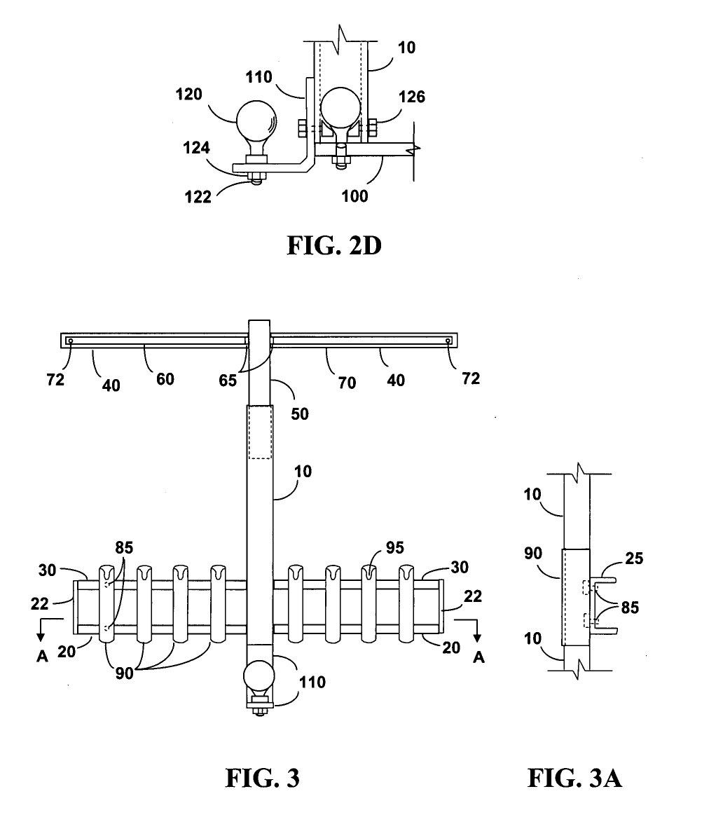

Referring to FIG. 1 and FIGS. 2A through 2C, a stem 100 is connected to lower end of the upright column element 10, the device forming an L-shape or J-shape when viewed from the side. The stem has an approximately rectangular cross-section and may be a solid metal, e.g. cast iron or steel, or a hollow tube, e.g. structural steel such as ASTM A36 or A572. The stem 100 is sized to be mated with a receiver hitch 210 installed on a vehicle 200. Such receiver hitches are of the type manufactured under the tradename Draw-Tite by Cequent Towing Products of Plymouth, Mich. In the preferred embodiment, the cross-sectional dimensions of the stem is 2 inch by 2 inch, typical of the dimensions of a Class 3 or Class 4 receiver hitch. Alternatively, the cross-section of the stem may be 1¼ inch by 1¼ inch, typical of a Class 1 or Class 2 hitch.

In the preferred embodiment, a tongue 110 is connected to the upright column element 10 for mounting a ball 120. In this embodiment, the tongue is oriented in the opposite direction from the stem, the device forming an inverted T-shape when viewed from the side. In one embodiment, the tongue has a hole 115 for receiving the anchor bolt 122 of the ball 120 fastened by a nut 124 or other fastening means. In the preferred embodiment, the tongue is a flat bar of structural steel such ASTM A36 or A572, but in other embodiments, may be cast iron or steel. In one embodiment, the stem and tongue are connected to the upright column element by electric-arc welding. Yet, similar to the connections of the crossbars, the stem and/or tongue may be connected to the upright column element by gas flux welding or mechanical fasteners. In another embodiment, the device has the stem but lacks a tongue for mounting a ball, the device forming an L-shape or J-shape when viewed from the side.

In another embodiment, referring to FIG. 3, the device is capable of vertical adjustment of the top cross bar to fit and hold taller rods or poles. In one embodiment, the column element is capable of telescoping whereby the upright column element has a lower part 10 and an upper part 50; the upper part of the column element, including the top crossbar, is extendable and is capable of extending upward to accommodate taller rods or poles and securely hold them. For example, the upper part 50 may be smaller than and fit inside the lower part 10 such that the upper and lower parts may be telescoping. The upper part 50 may be held in vertical position by a pin, set screw, thumbscrew, or other mechanical method, or simply by the force of friction.

In still another embodiment, referring to FIGS. 2B through 2C, a universal ball mount 15 has a tongue 110 for mounting a ball, a stem 100 for mating the receiver hitch 210, and an vertical stem 130 for holding the upright column element. The universal ball mount is removeably connected to the receiver hitch by a pin 220. The upright column element 10 is removeably connected to the vertical stem 130 by a pin 18. The universal ball mount offers the versatility of changing the upright column element and any crossbar(s). In one embodiment, the upright column element and crossbars is configured for the transport of fishing poles or rods. In other embodiments, the upright column element may be configured for the transport of other sports or outdoor equipment or gear such as bicycles, surf boards, sailboards, and so on. Equipment made by various manufacturers can be designed to connect to the universal ball mount whether made by an original equipment manufacturer, modified by an after-market company, or retrofitted by an end user. The universal ball mount may be made of solid or monolithic construction that is cast, e.g. sand cast, a prismatic shape milled to pre-determined tolerances, e.g. square mill stock, or a fabricated assembly that includes a combination of a flat bar connected to at least one structural tube, e.g. 2 inch by 2 inch.

Referring to FIG. 2D, the device is configured for use with a tongue hitch rather than a receiver hitch. In this configuration, the device would not require a stem 100 and may be connected to a ball 120′ mounted on a tongue 110′ of the tongue hitch using one or more grips 126. Alternatively, the device may be connected to the tongue 110 of a second device if the second device includes a tongue 110 as in the above description. The result would be the stacking of one device on a second device. Such stacking of devices would enable the carrying of an additional number of rods or poles.

Referring to FIGS. 1 and 3, a plurality of rod holders 90 are spaced at approximately 3 inch on center along lower crossbars 20 and 30, or alternatively, a single lower crossbar 25. Yet, the spacing of the rod holders can vary and does not have to be uniform. In the preferred embodiment, each rod holder has a nominal 2 inch diameter and is composed of a type of plastic known as Acrylonitrile Butadiene Styrene (ABS) plastic. Yet, the diameter of the rod holders and the material composition can vary. For example, the rod holders 90 can have diameters from 1¼ inch to 5 inches and the material composition can be many types of plastic, e.g. polyvinyl chloride, acrylic, polycarbonate, etc., many types of rubber, e.g. natural, nitrile, butyl, EPDM, as well as metals such as brass or galvanized steel. In the preferred embodiment, each rod holder has a vertical slot 95 in the top edge of the rod holder 90 to receive a strut that connects the reel to the rod or pole. In one embodiment, the vertical slot is approximately 1 inches wide by 3 inch long and the rod holders 90 are connected to the crossbars 20 and 30 with mechanical fasteners 85 such as hot-dip galvanized or electro-galvanized steel bolts. Yet, the vertical slot may have varying dimensions and the rod holders can be connected to the crossbars by other means, e.g. metal bands, plastic ties, or may be connected to a single crossbar 25 composed of a channel or plate as previously described.

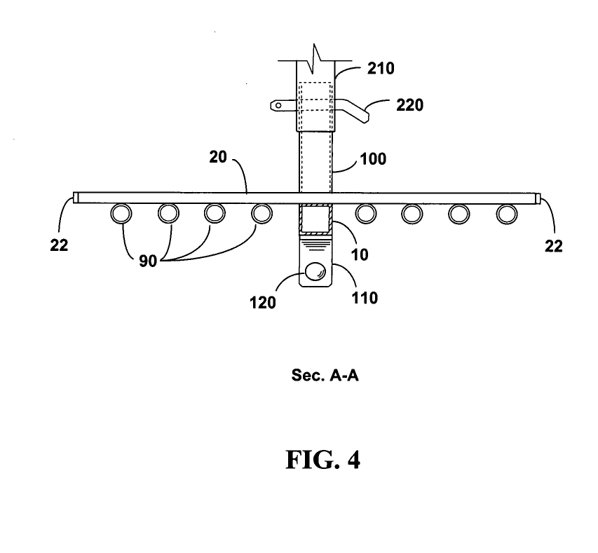

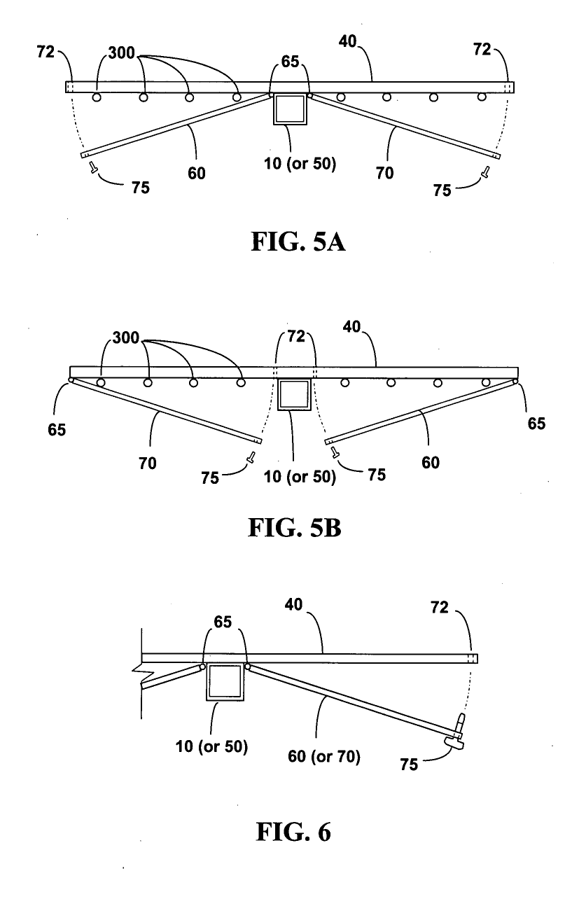

Referring to FIGS. 1, 4, 5A and 5B, the retainer bars 60 and 70 are connected to the upper crossbar 40 by a plurality of hinges 65. In one embodiment, the retainer bars are 1 inch wide flat bars composed of structural steel such as ASTM A36 or A572. In one embodiment, the crossbars are connected to the upright column element by electric-arc welding. Yet, the crossbars may be connected to the upright column element by gas-flux welding, chemical welding, adhesives, or mechanical connectors, e.g. bolts or screws depending on the material composition of the upright column element and the crossbars. In the preferred embodiment, all metal surfaces would have a polyester powder coated finish or a coating of similar quality.

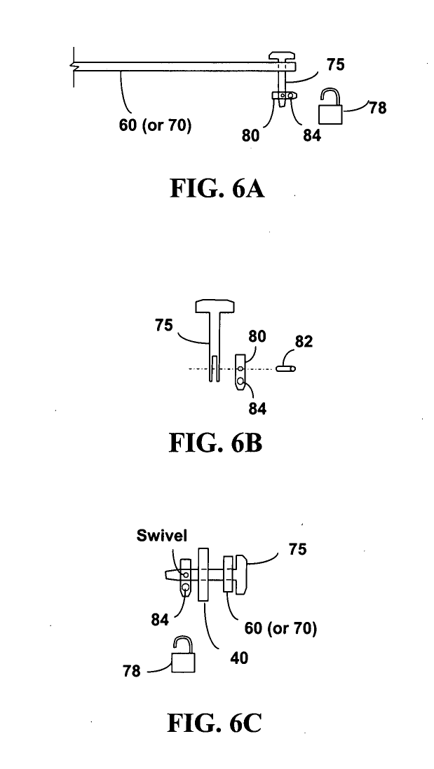

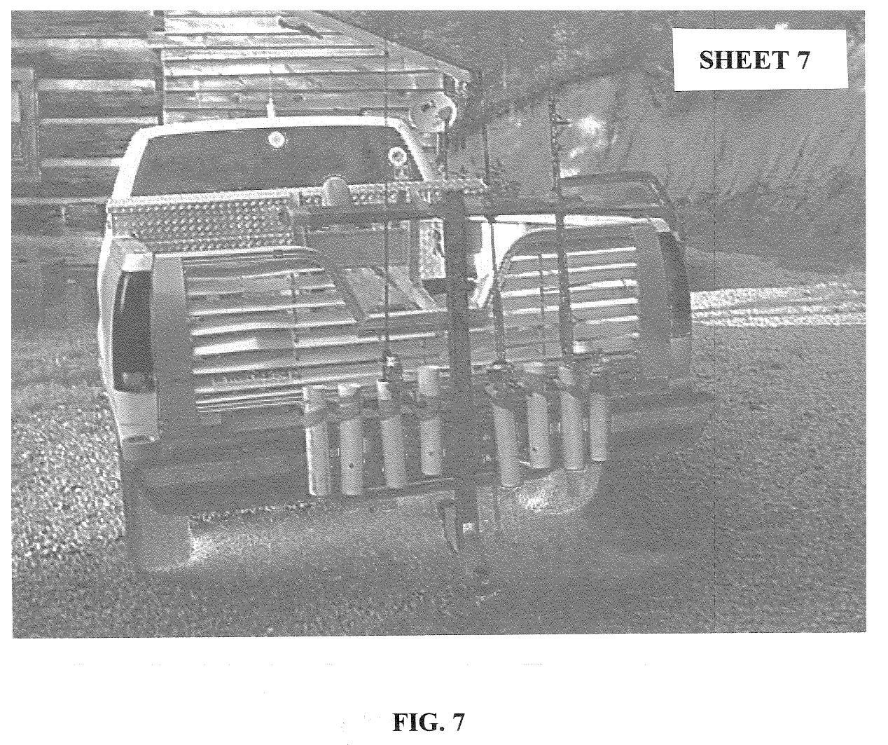

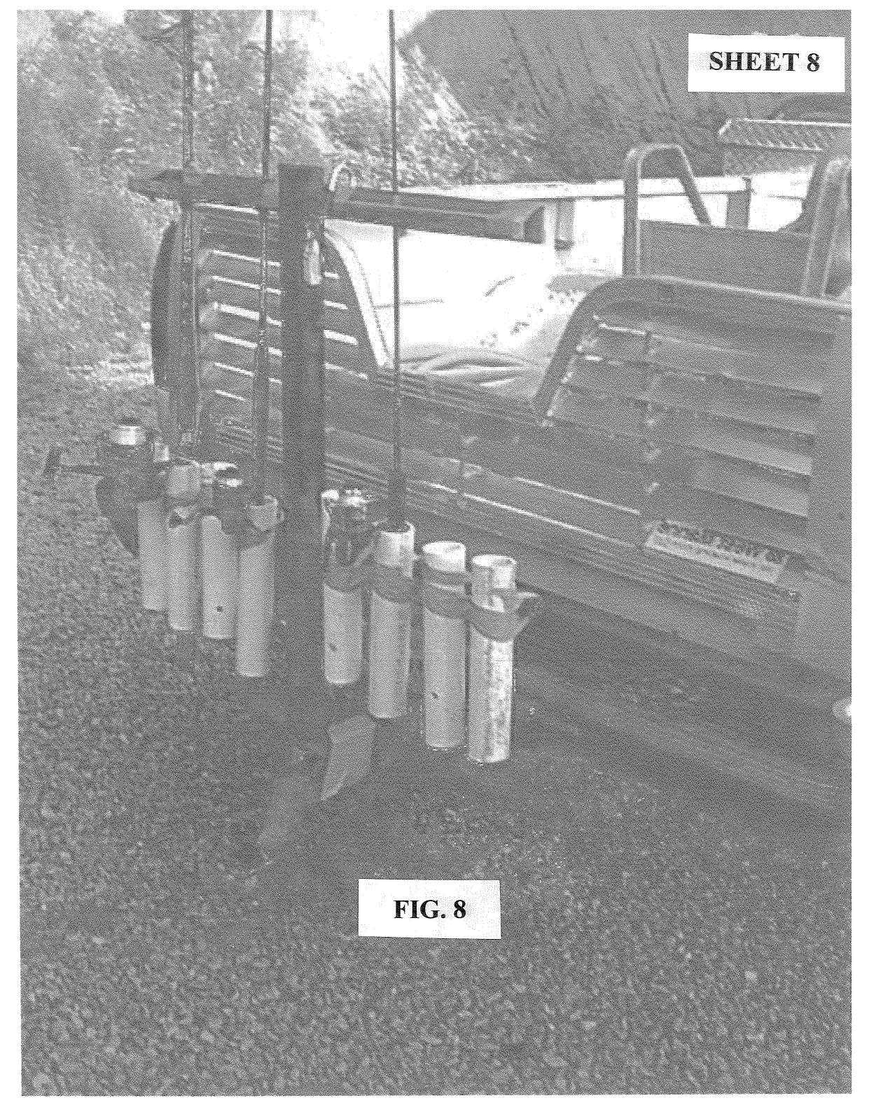

Referring to FIGS. 6 and 7, the device is removeably connected to the receiver hitch 210 located at the rear of a vehicle 200. Rods or poles 300 may be placed in a plurality of rod holders 90. A trailer may also be connected to the ball mounted on the tongue of the device whereby the tongue weight and load of the trailer is transmitted through the device to the receive hitch. The device is designed to transmit the loads, e.g. gravity, acceleration, vibration, required to maintain the existing rating of the hitch, for example, a Class 2 hitch should remain a Class 2 hitch. Referring to FIGS. 2A and 2B, both the stem 100 and tongue 110 are designed to transmit such loads; referring FIG. 2C, the stem 100 is a continuous element which is designed to transmit such loads; and referring to FIG. 2D, the tongue 110 is designed to transmit such loads. However, under some circumstances, it may not be possible to maintain the existing rating of the hitch, e.g. a Class 3 hitch may become a Class 2 hitch or a Class 2 hitch may become a Class 1 hitch. Under all circumstances, the device is designed to be at least a Class 1 hitch.

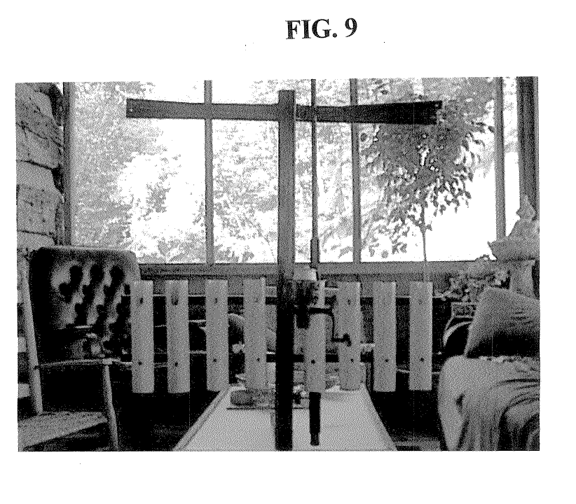

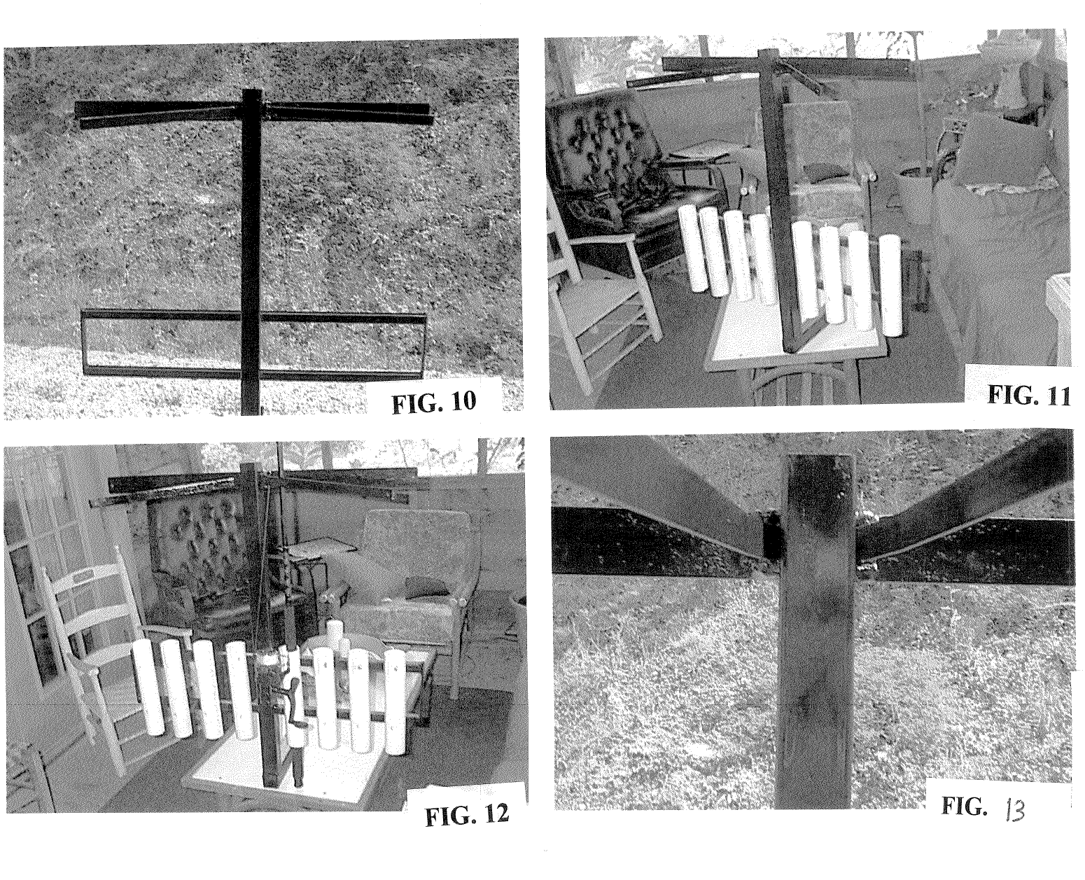

Referring to FIG. 9, the fully-assembled device is capable of holding rods or poles in an upright position when the device is not mounted on the vehicle 200. In the preferred embodiment, the stem 100 is perpendicular to the upright column element 10 and functions as a base when the device is not mounted on the vehicle by inserting the stem 100 in the receiver hitch 210 connected to the vehicle.

Referring to FIGS. 10 through 13, inclusive, the upright column element 10 and crossbars 20, 30 and 40 comprise a frame on which the remaining parts of the device are mounted. The frame can be fabricated as a single piece or fabricated in multiple pieces that can be assemble and disassembled depending on the intended method of delivery to user. Fabrication of the frame as a single piece is more convenient to the user because it does not require assembly. Yet, fabrication of the frame as multiple pieces would require less time to manufacture and less bulk if shipped to the end user.

In operation, the device is removeably connected to the vehicle 200 by inserting the stem 100 in the receiver hitch 210 and secured with a pin 220 through holes 215 and 215′. One or more rod holders 90 each receives a rod or pole for transport. A retainer bar 60 (or 70) clamps the rods or poles against the upper cross bar 40. A pin 75 is inserted through a hole 72 in the retainer bar and the upper crossbar to secure the rods or poles from damage or theft. In the preferred embodiment, the pin 75 is articulated and includes a latch 80 which swivels about a pin 82. The pin 75 may be automatically latched to hold the retained bar in position. The retainer bar 60 (or 70) may secured by insertion of a D-ring, carabineer, cotter pin, clip, or the like, in hole 84, or alternatively, may be locked via insertion of a padlock 78 or other locking means.

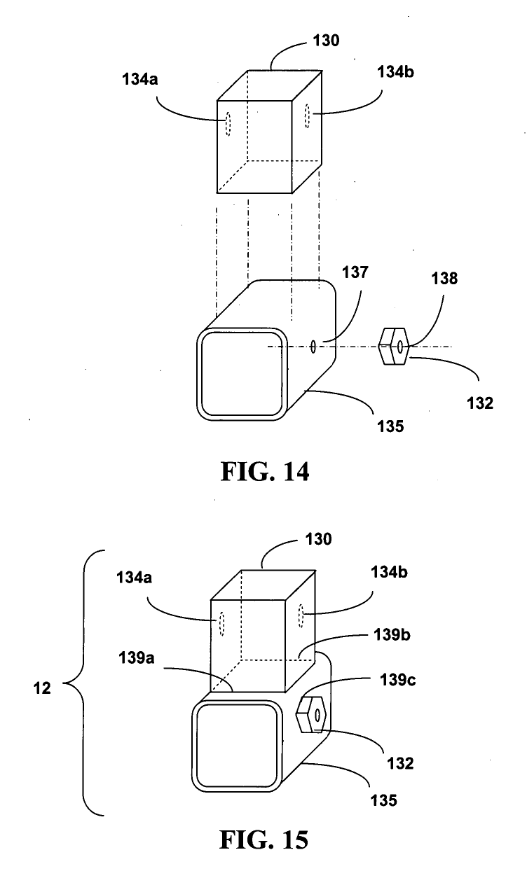

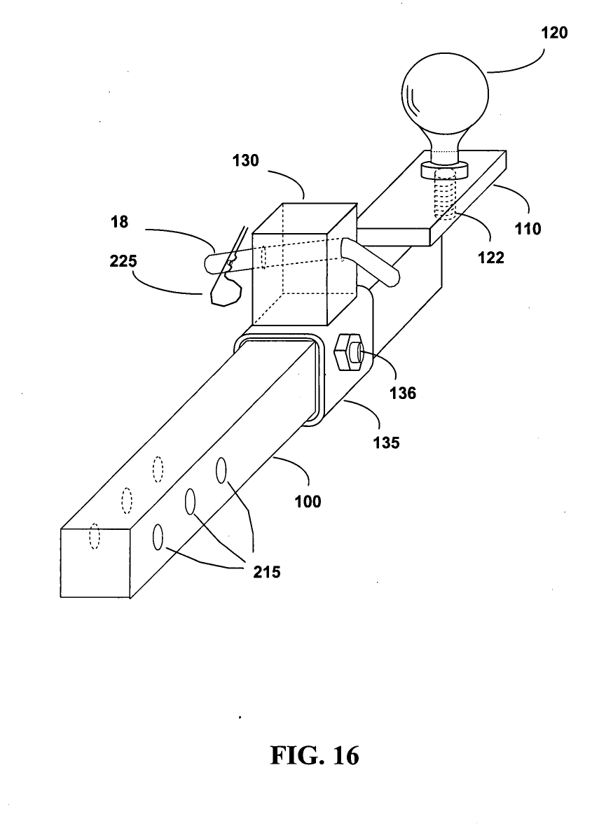

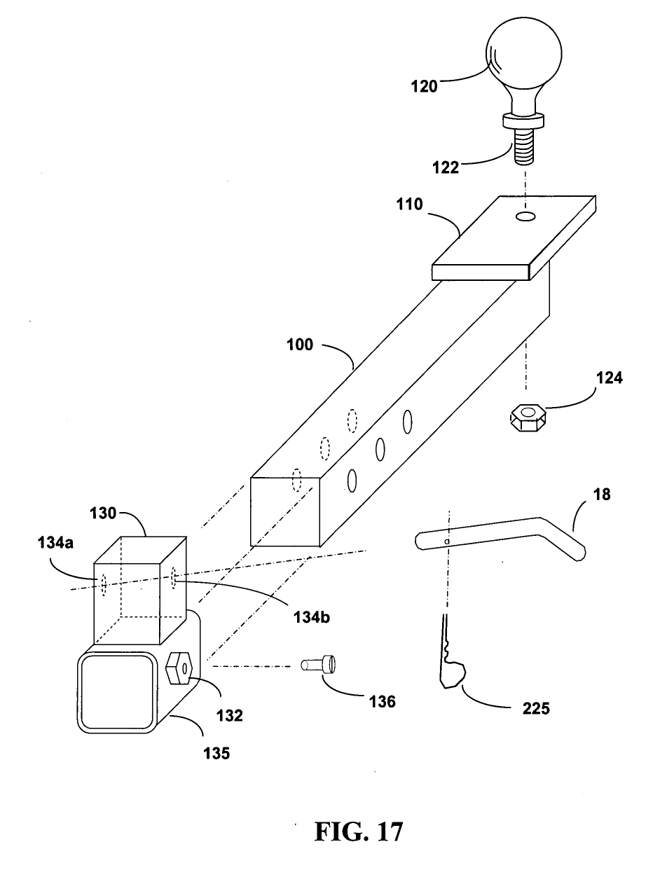

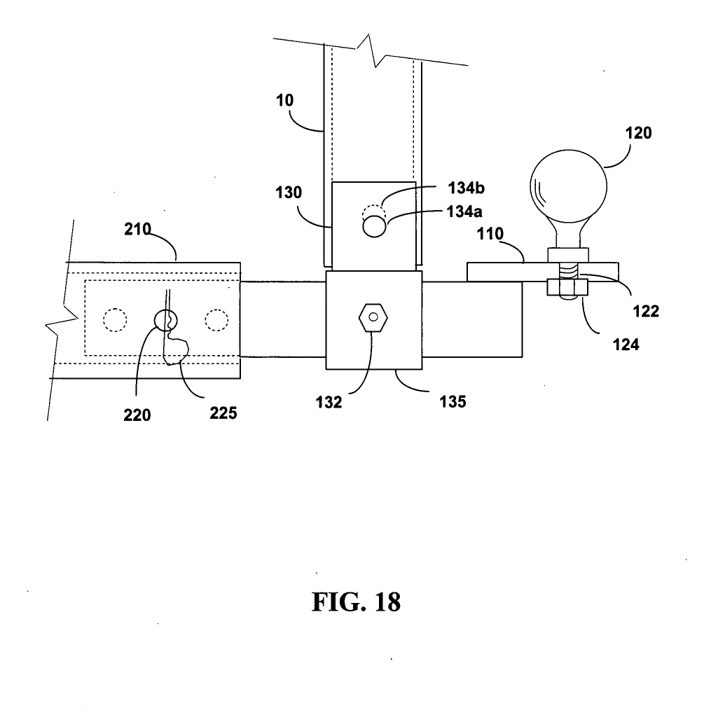

Referring to FIGS. 14 through 21, inclusive, a retrofit device 12 includes a stem 130, a sleeve 135, and a nut 132. The stem 30 is connected to a sleeve 135 which is capable of sliding onto the end of the stem 100 of an existing hitch. The nut 132 is connected to the sleeve 135 and is capable of receiving a screw 136, e.g. a machine screw or set screw, to hold the sleeve in position. In one embodiment, the stem, sleeve and nut are separate pieces connected by fillet welds 139a, 139b, and 139c. In another embodiment, the stem sleeve and nut are cast or molded out of metal, plastic or other material. In one embodiment, the nut may be a plate that is drilled with a hole 138 and threaded to receive a screw. In another embodiment, there is no need for a nut because the wall thickness of the sleeve is sufficient that the hole 137 can be threaded and receive the screw 136.

Referring to FIGS. 14, 15, 17 and 18, the holes 134a and 134b in the retrofit device 12 are offset from one each other so that the pin 18 passes through stem 130 and upright column element 10 at a slight angle θ. In one embodiment, the holes 134a and 134b are vertically offset by about 0.125 inches, and the pin 18 slopes downward at angle θ=tan⁻¹(0.125/W), where W=width of stem 130 in inches. The offset and/or angle results in less vibration between the stem 130 and upright column element. In one embodiment, the offset is vertical. In other embodiments, the offset may be horizontal or a combination of vertical and horizontal, and may be more or less than 0.125 inches.

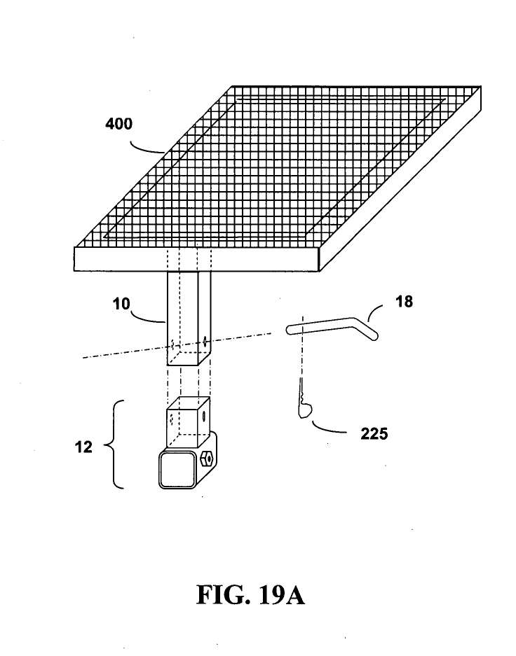

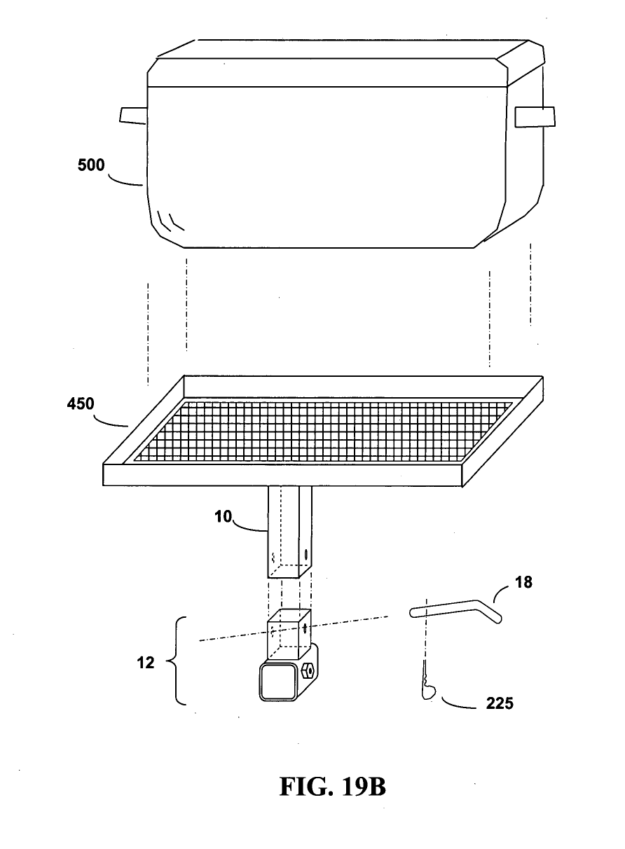

Referring to FIGS. 19A and 19B, accessories are removeably connected to stem 100 by retrofit device 12 and secured by pin 18 and a cotter pin 225. In one embodiment, the accessory is a platform 400 which forms a bridge from the rear of the vehicle to the trailer. In another embodiment, the accessory is a platform 450 which supports a storage container 500, e.g. ice chest.

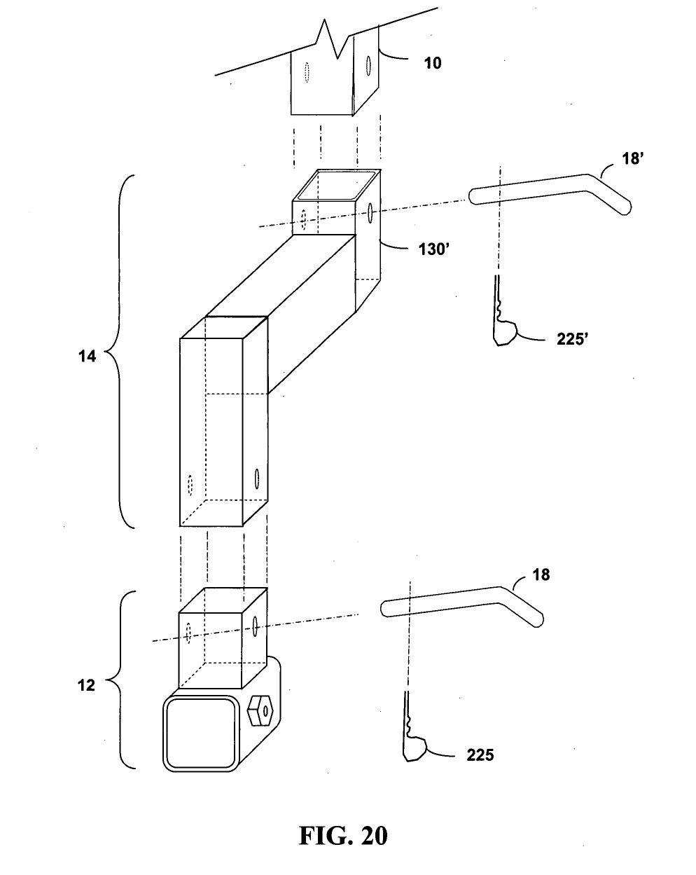

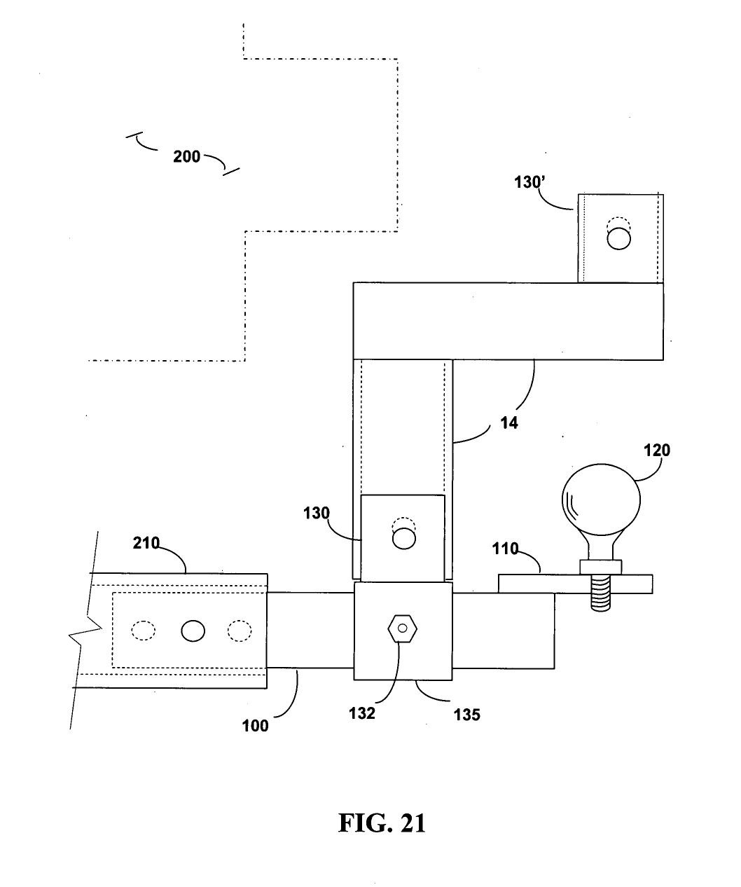

Referring to FIGS. 20 and 21, an adapter device 14 is removeably connected to stem 130 of the retrofit device 12 and secured a pin 18′ and a cotter pin 225′. The adapter device enables positioning the upright column element at a distance away from the vehicle 200. In one embodiment, the adapter device 14 is necessary due to presence of a wide bumper. In another embodiment, the adapter device may be connected to stem 130 of universal ball mount 15. In still other embodiments, the adapter device may be unnecessary.

In operation, the retrofit device 12 is removeably connected to the stem 100 of a removable ball mount of a ball mount hitch. The retrofit device is secured in position by tightening the screw 136. An accessory having an upright column element 10 is mounted on the retrofit device 12 and secured by a pin 18 and cotter pin 225. If necessary, the adapter device 14 is first mounted on the retrofit device 12 and the upright column element 10 is then mounted on the adapter device 14. In one embodiment, the pin 18 is a rod of hardened steel bent at one end and with a small hole at the other end. In other embodiments, the pin 18 may be a steel bolt with a head at one end and threads at the other end. In still other embodiments, the pin 18 may be made of other materials.

From the foregoing it will be appreciated that although specific embodiments of the invention have been described herein for purposes of illustration, various modifications may be made without deviating from the spirit and scope of the invention. For example, the device can be used to hold other equipment or gear in addition to fishing rods and thus the number and configuration of rod holders can be varied. Further, invention can include a “universal” ball mount that affords the versatility to the end user to connect any type of holder, e.g. rack, shelf, bracket, frame, etc. to the ball mount. Still further, invention can include a retrofit device for use with existing ball mounts and receiver hitches. Yet still further, the invention can include an adaptor device for vehicles with bumpers of large width. In this way, the device can be used for transporting equipment and gear for various sports or outdoor activities as well as occupations that require transporting of equipment or gear to and from worksites. Accordingly, the invention is not limited except as to the appended claims and their equivalents.

What is claimed is:

1. A device comprising:
an upright column element;
a crossbar connected to the upright column element;
a plurality of rod holders connected to the crossbar;
whereby each rod holder receives the end of a rod or pole; and
a stem connected to the upright column element whereby the stem is removeably connected to a receiver hitch.

2. The device in claim 1 wherein the upright column element is removeably connected to the stem.

3. A device comprising:
an upright column element;
at least one lower crossbar connected to the upright column element;
at least one upper crossbar connected to the upright column element;
a plurality of rod holders connected to the lower crossbar;
whereby each rod holder receives the end of a rod or pole;
a stem connected to the upright column element whereby the stem is removeably connected to a receiver hitch; and
at least one retainer bar rotatably connected to the upper crossbar or upright column element.

4. A device comprising:
a ball mount having a first end and a second end;
a sleeve encircling the ball mount;
a vertical stem affixed atop the sleeve;
wherein the first end of the ball mount is capable of mating with a receiver hitch;
wherein the second end of the ball mount is capable of mounting a ball;
wherein the sleeve is positioned between the first end and the second end.

5. The device of claim 4 wherein a hole exists in at least one wall of the sleeve and the hole is threaded to receive a screw.

6. The device of claim 4 wherein a hole exists through the thickness of the stem to receive a pin and a line drawn through the centers of the holes is inclined.

7. The device of claim 4 wherein holes exist in opposite walls of the stem to receive a pin and the holes are offset from each other.

8. The device of claim 4 wherein a wherein an accessory is mounted on the vertical stem and secured by a pin through the hole or holes in the stem.

9. The device of claim 4 wherein an adapter is first mounted on the vertical stem and secured by a pin and then an accessory is mount on the adapter.

10. The device of claim 1 wherein each rod is uniquely identified with a registration number and the registration number is entered in a database.

11. The device of claim 2 wherein each rod is uniquely identified with a registration number and the registration number is entered in a database.
